(19) United States
(12) Patent Application Publication
(10) Pub. No.: US 2008/0278742 A1
(43) Pub. Date: Nov. 13, 2008

(54) SYSTEM AND METHOD FOR CUSTOMIZED ROUTING OF DOCUMENT DATA INTERCEPTED THROUGH PORT REDIRECTION

(76) Inventor: Arthur J. Poirier, North Narrabeen (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/747,074

(22) Filed: May 10, 2007

(51) Int. Cl. G06F 3/12

(52) U.S. Cl. 358/1.15

(57) ABSTRACT

The subject application is directed to a system and method for customized routing of document data intercepted though port redirection. Output data is first received from at least one application via a virtual port and stored into an associated storage. Display data is generated on an associated display representing an electronic document of the output data, as well as document processor display data representing available document output devices. Selection data is then received corresponding to document output devices selected by an associated user. Copy count data representing a number of copies to be output on each selected document output device is then received for each document output device. Output data is then output from the data storage to each selected document output device such that each selected document output device outputs a number of copies corresponding to copy count data associated therewith.

### BACKGROUND OF THE INVENTION

The subject application is directed generally to rendering of electronically stored documents. The subject application is particularly useful in assembly and rendering of electronically stored documents intercepted from one or more virtual output ports and directing such output to generate a differing numbers of copies for more than one document output device.

There are many different applications, some of which may be embedded on dedicated devices, which are used in a typical office or document processing environment. Such applications include word processing, facsimile transmission, spread sheet generation, slide show generation, scanning, optical character recognition, computer aided design, or database usage. Typically, such applications include a mechanism to allow for generating an output, such as print out, electronic mail, plot, transparency rendering, or the like.

Often many copies of a document need to be generated. Other times a document will need to be output to multiple locations, or in multiple formats with a number of required copies that my differ by output device. By way of example, in a classroom setting, one classroom may require 35 copies, and another classroom 40 copies. Each classroom may have its own printer to which document copies are directed. Additionally, printers or drivers do not have an ability to automatically identify printouts, collate pages in multiple copies, or print separator pages between multiple copies.

Conventional software, or associated output drivers, further allow for selection of different output devices, such as directing a facsimile output rather than printing. Sending to multiple devices, such as multiple printers or to printers, facsimile, electronic mail, or the like, requires a user to enter into a series of operations wherein each device is selected, and a document or documents sent to such device, prior to selection of another device for document submission.

While some earlier systems allowed for dividing print jobs to multiple printers concurrently to save time or allocate workload, such systems are typically tied to a single device or software application. Additionally, systems which merely balance loads associated with document processing operations do not address situations where different target locations require unique numbers of copies.

### SUMMARY OF THE INVENTION

In accordance with another embodiment of the subject application, there is provided a system and method for rendering of electronically stored documents.

Further, in accordance with another embodiment of the subject application, there is provided a system and method for assembling and rendering of electronically stored documents intercepted from one or more virtual output ports and directing such output to generate a differing number of copies for more than one document output device.

Still further, in accordance with one embodiment of the subject application, there is provided a system for customized routing of document data intercepted through port redirection. The system comprises virtual port means adapted for receiving output data from at least one application and a data storage adapted for storing output data received via the virtual port. The system also comprises means adapted for generating, on an associated display, display data representative of at least one electronic document associated with output data stored in the data storage. The system further comprises means adapted for generating, on the display, document processor display data representative of a plurality of available document output devices and means adapted for receiving selection data representative of selected document output devices from the plurality thereof. The system also includes means adapted for receiving, for each selected document output device, copy count data representative of a number of copies to be output on each corresponding document output device and means adapted for outputting output data from the data storage to each selected document output device such that each selected document output device outputs a number of copies corresponding to copy count data associated therewith.

In one embodiment of the subject application, the system further comprises means adapted for receiving separator page data representative of a characteristic of a job information page unique to each selected document processing device. Preferably, the separator data includes at least one of data representative of an identity of and copy count associated with each document output device. In another preferred embodiment, the system also comprises means adapted for commencing generation of each job information page as a separator page between each copy output by each document output device.

In another embodiment of the subject application, the system further comprises at least one software driver associated with each of the plurality of available document output devices, and wherein output data is received into the virtual port therefrom.

In yet another embodiment of the subject application, the at least one document output device includes a multifunction peripheral, and wherein the at least one software driver is directed to commence at least one operation chosen from the set of printing, facsimile transmission, and electronic mail transmission.

In a further embodiment, the output data includes graphical image data.

Still further, in accordance with one embodiment of the subject application, there is provided a method for customized routing of documents data intercepted through port redirection in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for customized routing of document data intercepted though port redirection according to one embodiment of the subject application;

FIG. 2 is a block diagram illustrating controller hardware for use in the system for customized routing of document data intercepted though port redirection according to one embodiment of the subject application;

FIG. 3 is a functional diagram illustrating the controller for use in the system for customized routing of document data intercepted though port redirection according to one embodiment of the subject application;

FIG. 4 is a block diagram illustrating a workstation for use in the system for manipulation of document data intercepted through port redirection according to one embodiment of the subject application;

FIG. 5 is a flowchart illustrating a method for customized routing of document data intercepted though port redirection according to one embodiment of the subject application; and

FIG. 6 is a flowchart illustrating a method for customized routing of document data intercepted though port redirection according to one embodiment of the subject application.

### DETAILED DESCRIPTION OF THE PREFERRED EMBODIMENT

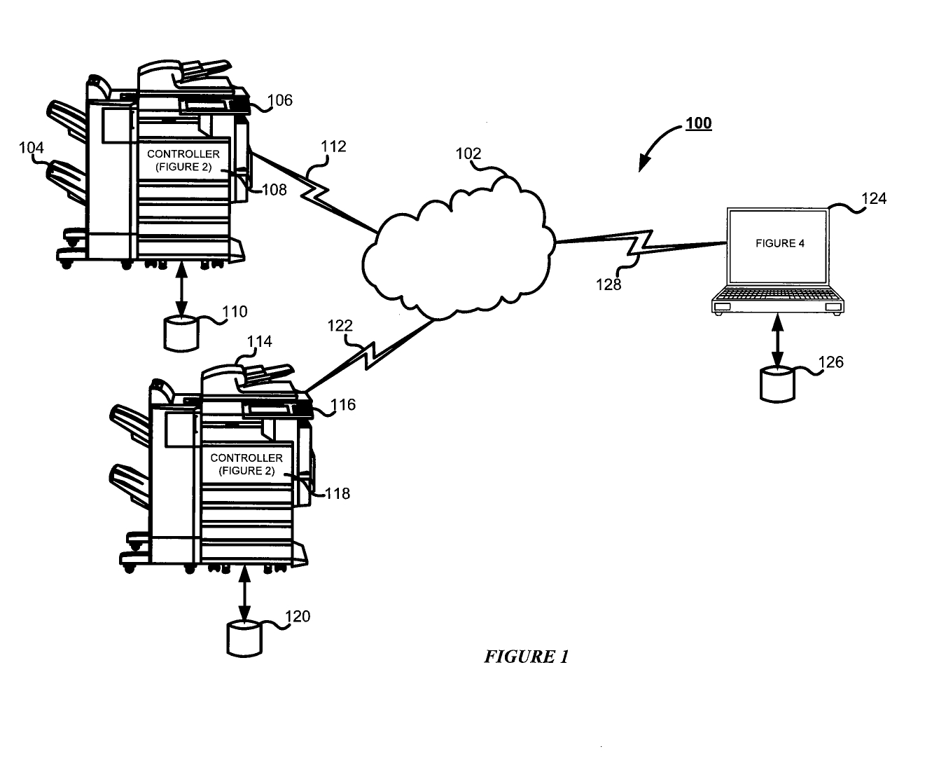

The subject application is directed to a system and method for rendering of electronically stored documents. In particular, the subject application is directed to a system and method for assembling and rendering of electronically stored documents intercepted from one or more virtual output ports and directing such output to generate a differing number of copies for more than one document output device. It will become apparent to those skilled in the art that the system and method described herein are suitably adapted to a plurality of varying electronic fields employing virtual ports, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for customized routing of document data intercepted though port redirection in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a first document output or processing device 104 and a second document processing device 114, depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the first document processing device 104 and the second document processing device 114 are suitably adapted to provide document processing services to external or network devices. Preferably, the first document processing device 104 and the second document processing device 114 include hardware, software, and any suitable combination thereof, configured to interact with an associated user, a networked device, or the like. It will be apparent to those skilled in the art that the use of two document processing devices 104 and 114 are for example purposes only and the subject application is capable of implementation using any number of document processing devices coupled to the computer network 102.

According to one embodiment of the subject application, the first document processing device 104 and the second document processing device 114 are suitably equipped to receive a plurality of portable storage media, including, without limitation, Firewire drive, USB drive, SD, MMC, XD, Compact Flash, Memory Stick, and the like. In accordance with one particular embodiment of the subject application, the first document processing device 104 and the second document processing device 114 further include associated user interfaces 106 and 116, respectively, such as a touch-screen, LCD display, touch-panel, alpha-numeric keypad, or the like, via which an associated user is able to interact directly with the corresponding first document processing device 104 and the second document processing device 114. In accordance with the preferred embodiment of the subject application, the user interfaces 106 and 116 are advantageously used to communicate information to the associated user and receive selections from the associated user. The skilled artisan will appreciate that the user interfaces 106 and 116 comprise various components, suitably adapted to present data to the associated user, as are known in the art. In accordance with one embodiment of the subject application, the user interfaces 106 and 116 comprise a display, suitably adapted to display one or more graphical elements, text data, images, or the like, to an associated user, receive input from the associated user, and communicate the same to a corresponding backend component, such as a controller 108 or 118, as explained in greater detail below. Preferably, the document processing devices 104 and 114 are communicatively coupled to the computer network 102 via suitable communications links 112 and 122, respectively. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

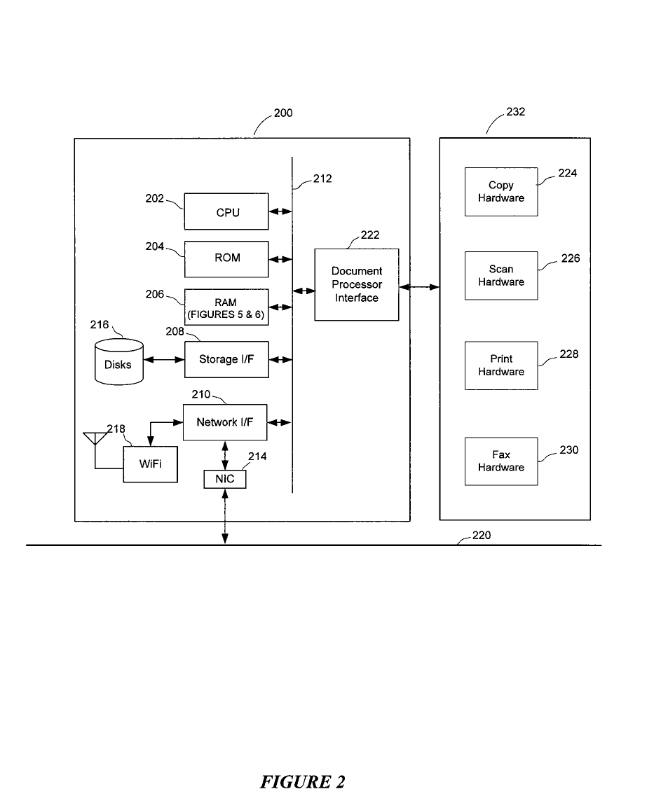

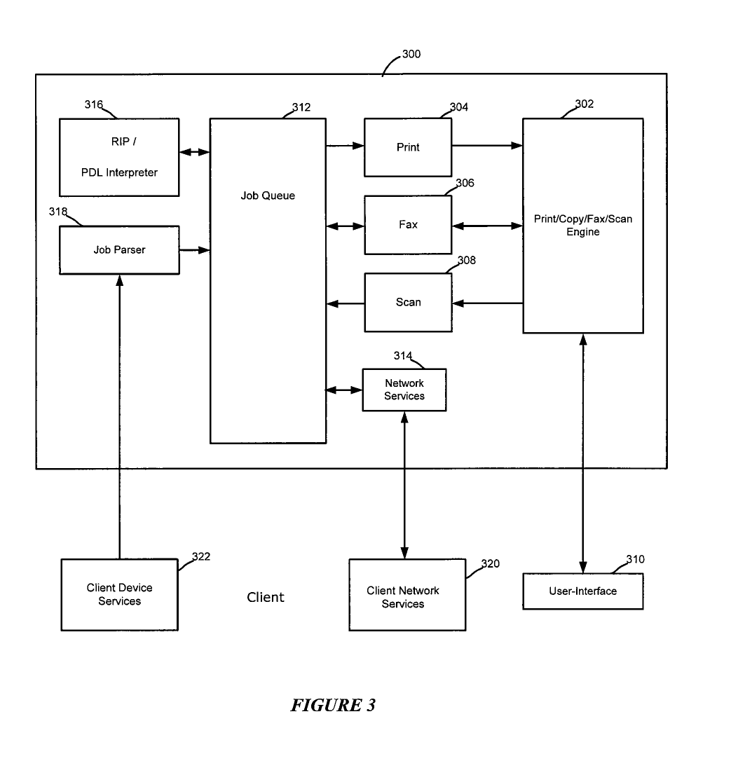

In accordance with one embodiment of the subject application, the document processing devices 104 and 114 further incorporate backend components, designated as the controller 108 and the controller 118, respectively, which are suitably adapted to facilitate the operations of the corresponding document processing devices 104 and 114, as will be understood by those skilled in the art. Preferably, the controllers 108 and 118 are embodied as hardware, software, or any suitable combination thereof, configured to control the operations of the associated document processing devices 104 and 114, facilitate the display of images via the user interfaces 106 and 116, direct the manipulation of electronic document data, and the like. For purposes of explanation, the controllers 108 and 118 are used to refer to any myriad of components associated with the document processing devices 104 and 114, including hardware, software, or combinations thereof, functioning to perform, cause to be performed, control, or otherwise direct the methodologies described hereinafter. It will be understood by those skilled in the art that the methodologies described with respect to the controllers 108 and 118 are capable of being performed by any general purpose computing system, known in the art, and thus the controllers 108 and 118 are representative of such a general computing device and is intended as such when used hereinafter. Furthermore, the use of the controllers 108 and 118 hereinafter is for the example embodiment only, and other embodiments, which will be apparent to one skilled in the art, are capable of employing the system and method for customized routing of document data intercepted through port redirection of the subject application. The functioning of the controllers 108 and 118 will better be understood in conjunction with the block diagrams illustrated in FIGS. 2 and 3, explained in greater detail below.

The first document processing device 104 is communicatively coupled to a data storage device 110, and communicatively coupled to the second document processing device 114 is a data storage device 120. In accordance with one embodiment of the subject application, the data storage devices 110 and 120 are any mass storage devices known in the art including, for example and without limitation, magnetic storage drives, a hard disk drive, optical storage devices, flash memory devices, or any suitable combination thereof. In the preferred embodiment, the data storage devices 110 and 120 are suitably adapted to store a document data, image data, electronic database data, or the like. It will be appreciated by those skilled in the art that while illustrated in FIG. 1 as being separate components of the system 100, the data storage devices 110 and 120 are capable of being implemented as internal storage components of their corresponding document processing devices 104 and 114, components of their corresponding controllers 108 and 118, or the like, such as, for example and without limitation, an internal hard disk drive, or the like.

The system 100 illustrated in FIG. 1 further depicts a user device 124, in data communication with the computer network 102 via a communications link 128. It will be appreciated by those skilled in the art that the user device 124 is shown in FIG. 1 as a laptop computer for illustration purposes only. As will be understood by those skilled in the art, the user device 124 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 128 is any suitable channel of data communications known in the art including, but not limited to wireless communications, for example and without limitation, Bluetooth, WiMax, 802.lla, 802.llb, 802.llg, 802.11(x), a proprietary communications network, infrared, optical, the public switched telephone network, or any suitable wireless data transmission system, or wired communications known in the art. Preferably, the user device 124 is suitably adapted to generate and transmit electronic documents, document processing instructions, user interface modifications, upgrades, updates, personalization data, or the like, to the first document processing device 104, the second document processing device 114, or any other similar device coupled to the computer network 102. The user device 124 of the subject application also includes a port redirector component, various software drivers, applications, and the like, as will be explained in greater detail below.

In accordance with one embodiment of the subject application, the user device 124 includes an associated memory, illustrated in FIG. 1 as the data storage device 126. It will be appreciated by those skilled in the art that the data storage device 126 is any mass storage device known in the art including, for example and without limitation, magnetic storage drives, a hard disk drive, optical storage devices, flash memory devices, or any suitable combination thereof. According to one particular embodiment of the subject application, the data storage device 126 is suitably adapted to store output data, document data, image data, electronic database data, or the like. It will be appreciated by those skilled in the art that while illustrated in FIG. 1 as being a separate component of the system 100, the data storage device 126 is capable of being implemented as internal storage component of the user device 124, such as, for example and without limitation, an internal hard disk drive, or the like. As will be addressed below, the data storage device 126 is capable of storing output data corresponding to data received by a virtual port, e.g., the port redirector, and thereby allow manipulation thereof by an associated user.

Turning now to FIG. 2, illustrated is a representative architecture of a suitable backend component, i.e., the controller 200, shown in FIG. 1 as the controllers 108 and 118, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controllers 108 and 118) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

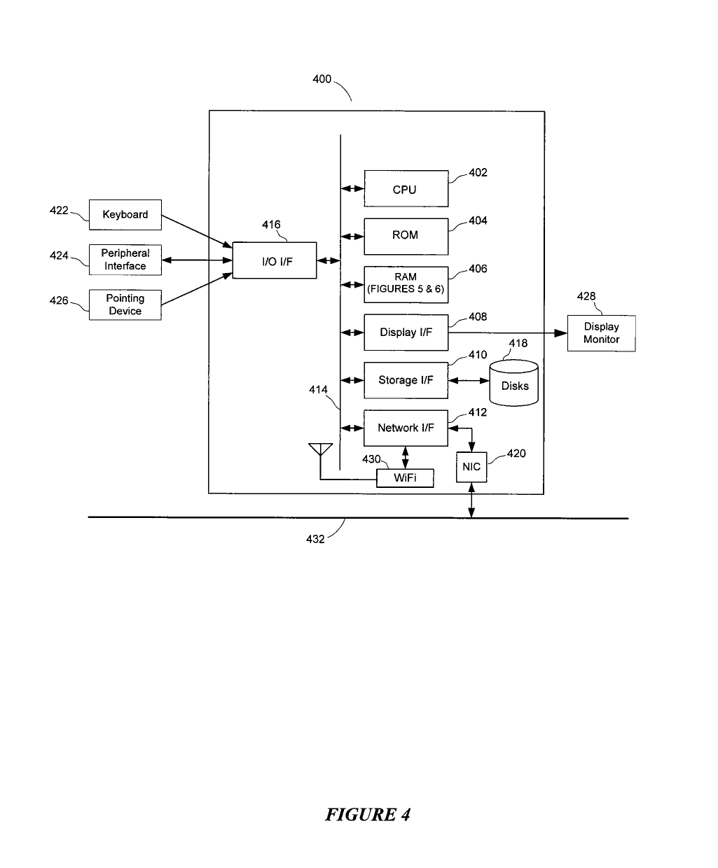

Turning now to FIG. 4, illustrated is a hardware diagram of a suitable workstation 400, illustrated in FIG. 1 as the user device 124, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, output data is received from at least one application via a virtual port. The output data received via the virtual port is then stored into an associated storage. On an associated display, display data is generated representing at least one electronic document associated with the output data stored in the associated data storage. Document processor display data is also generated on the display representing a plurality of available document output devices. Selection data is then received corresponding to one or more document output devices selected from among the available document output devices. Copy count data representing a number of copies to be output on each selected document output device is then received for each corresponding document output device. Output data is then output from the data storage to each selected document output device such that each selected document output device outputs a number of copies corresponding to copy count data associated therewith.

In accordance with one example embodiment of the subject application, a software component, referenced hereinafter as a port redirector, is initiated on the user device 124. It will be understood by those skilled in the art that the port redirector facilitates the interception and receipt of output data for customized routing of document data to one or more selected document processing devices 104 and 114. In addition, the skilled artisan will appreciate that the port redirector is any hardware, software, or suitable combination thereof, capable of performing the functions described hereinafter. Following initiation, the port redirector component establishes a virtual port on the user device 124 to which software drivers associated with applications resident on the device 124 are able to output electronic documents. The skilled artisan will appreciate that each application on the user device 124 is capable of having one or more corresponding software drivers to facilitate the output of documents generated thereon.

The port redirector component then receives output data, e.g., data sent to the virtual port from one or more of the applications resident on the user device 124, corresponding to electronic documents to be output to one or more associated document processing devices 104 and 114. The skilled artisan will appreciate that suitable output data includes, for example and without limitation electronic document data, image data, and the like. Further, in accordance with one embodiment of the subject application, the software drivers associated with each application are capable of being directed to commence a document processing operation, such as printing, facsimile, electronic mail, storage, or the like. That is, the software driver is directed by the user via the corresponding application, to commence a selected document processing operation, whereafter the software driver prepares the document associated with the application prior to transmitting the document, or output data, to the virtual port. The skilled artisan will appreciate that the output data communicated from the software driver to the virtual port is capable of comprising, for example and without limitation, graphical image data, post-raster image processing graphical image data, or the like.

The output data received from the software drivers by the port redirector is then stored in a designated location on the data storage device 126 associated with the user device 124. Upon receipt and storage of the output data, the port redirector component directs the initialization of a graphical user interface on the user device 124 to display document images corresponding to the stored output data. According to one embodiment of the subject application, the graphical user interface is initiated on the user device 124 so as to generate graphical representations of at least one electronic document of the received output data visible to the associated user. The skilled artisan will appreciate that the graphical user interface is also capable of being generated on a thin client. For example, the port redirector and corresponding applications are accessed via an associated thin client, such as a web browser over the computer network 102.

The port redirector component then identifies the document processing devices 104 and 114 that are accessible to the user device 124 via the computer network 102 and available for the performance of selected document processing operations. The graphical user interface associated with the port redirector component then displays the available document processing devices to the user of the associated user device 124. The port redirector component, via the graphical user interface, then receives selection data from the user corresponding to one or more available document processing devices 104 and 114 to be used for outputting the data, i.e., performing the selected document processing operations. From the graphical user interface, the user is prompted to provide copy count data and separator page data associated with a first copy set. The skilled artisan will appreciate that the use of the term set references a group of copies of the output data to be output by one or more of the available document processing devices 104 and 114. The port redirector component then receives copy count and separator page content for the copy set via the graphical user interface from the associated user corresponding to a selected number of copies of the output data to be output by a selected document processing device 104 or 114, as well as text, identification, job information, or other suitable data for inclusion on a separator page accompanying and separating each set of copies.

The port redirector component then determines whether any additional sets of copies are to be output from the output data. When another set is determined to be needed, the user is prompted for the copy count data and the separator page content via the associated graphical user interface. Thereafter, the port redirector component receives the associated copy set data, e.g., the copy count and separator page content from the user via the graphical user interface. When the port redirector component determines that no additional sets of copies are to be generated from the output data, the port redirector component facilitates the generation of modified output data. In accordance with one embodiment of the subject application, the modified output data includes the copy count data, the separator page content data, and the original output data. The modified output data is then stored in the data storage device 126. Thereafter, the modified output data is output to the document processing devices 104 and 114 for further processing.

For example, when an associated user desires to print a predetermined number of sets of documents, e.g., copies of a document for 30 students in a first classroom, 28 students in a second classroom, 45 students in a third classroom, and 25 students in a fourth classroom. In addition, the user desires to employ the first document processing device 104 for outputting the documents for the first and second classrooms and the second document processing device 114 for the third and fourth classrooms. In accordance with one embodiment of the subject application, the user is presented, via the port director component associated with the user device 124, a graphical user interface to facilitate the selection of documents, set the number of copies, set the output destinations, create separator pages, and the like.

Continuing with the example set forth above, the port redirector component first establishes a virtual port on the user device 124 that appears as a printer to applications on the user device 124, e.g., a word processing application. The user, via the application driver, selects a given document for printing, which is sent to the virtual port. The port redirector first stores the document, documents, or output data, at a particular location on the data storage device 126. A graphical user interface is then initiated on the user device 124 by the port redirector component in response to the receipt and storage of the output data at the virtual port. The graphical user interface then displays those documents in the virtual port to the user for selection thereof, modification, or the like. The port redirector then identifies those document processing devices 104 and 114 that are available and accessible to the user device 124 and displays those devices 104 and 114 to the user via the graphical user interface. The user selects those document processing devices 104 and 114 to be used to print the document or documents.

The user is then prompted, via the graphical user interface, to select the number of copies and any separator page content for the first set of copies. For example, the user selects the first document processing device 104, selects 30 copies, and defines a text string for inclusion on the separator page indicating that the first copy set is destined for the first document processing device 104 and the first classroom. Once the user has finished inputting the information for the first set, the user is prompted to input the output information for each additional set destined for the selected output devices 104 and 114. Thus, as will be understood by those skilled in the art, the user selects the first document processing device 104 for the second set of copies, along with setting the number of copies at 28, and the separator page content indicating the set is for classroom 2; the user selects the second document processing device 114 for the third set of copies, along with setting the number of copies at 45, and the separator page content indicating the set is for classroom 3; the user selects the second document processing device 114 for the fourth set of copies, along with setting the number of copies at 25, and the separator page content indicating the set is for classroom 4.

Once the user has finished selecting the number of sets, e.g., 4, the port redirector component then generates modified output data, which is then stored in the data storage device 126. The modified output data includes the four sets of data to be output, including the number of copies, the individual separator pages, and the original document data. This is then communicated to the designated document processing devices 104 and 114, in accordance with the user selections made previously. In accordance with one embodiment of the subject application, in the generation of the modified output data, the port redirector alters the content of the print request to define the number of copies to be printed, makes copies of the print request so that each set is capable of having a unique NumCopies attribute (as will be understood by those skilled in the art), build new print requests, e.g., the separator pages, and concatenate these components in such a way that they appear to the document processing devices 104 and 114 as a single print request, complete with paper selections and finishing options.

In this example, as the user has selected multiple devices 104 and 114, the port redirector generates two sets of modified data, the first corresponding to those copy sets destined for the first document processing device 104, e.g., the first and second copy sets, and the second corresponding to those copy sets destined for the second document processing device 114, e.g., the third and fourth copy sets. The first modified data is then communicated to the first document processing device 104, which processes the print request and outputs the first and second copy sets, separated by the separator pages, e.g., prints the first separator page, then 30 copies of the selected documents, then the second separator page, and 28 copies of the selected documents. The second modified data is then communicated to the second document processing device 114, which processes the print request and outputs the third and fourth copy sets, separated by the separator pages, e.g., prints the third separator page, then 45 copies of the selected documents, then the fourth separator page, and 25 copies of the selected documents.

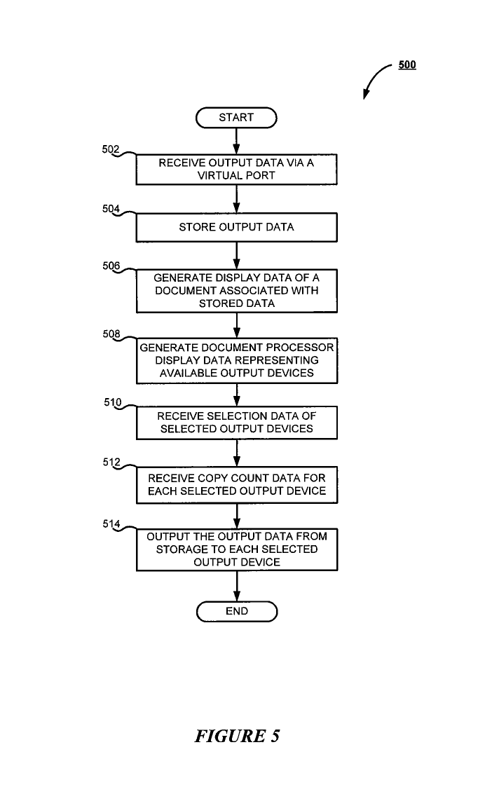

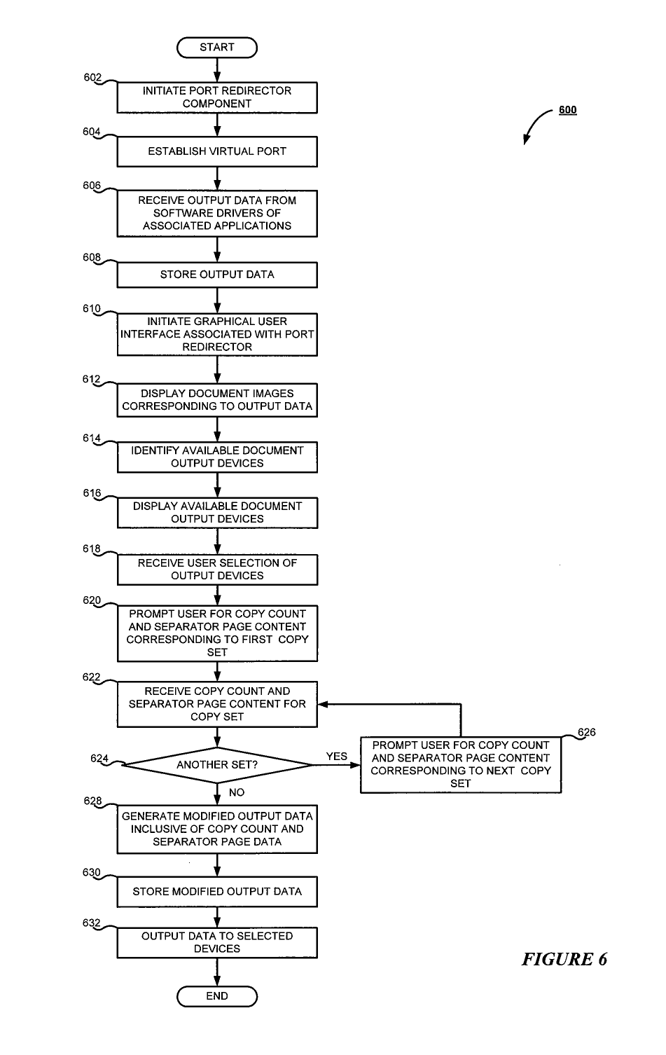

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for customized routing of document data intercepted though port redirection in accordance with one embodiment of the subject application. Beginning at step 502, output data is received via a virtual port, such as a virtual port generated by a port redirector component resident on the user device 124 from at least one software application operative on the user device 124. In accordance with one embodiment of the subject application, the port redirector component is any hardware, software, or suitable combination thereof, functioning to intercept output data from software applications. Preferably, the port redirector establishes a virtual port on the user device 124 to which one or more software drivers associated with the applications are capable of sending output data. It will be appreciated by those skilled in the art that suitable software applications include, for example and without limitation, word processing applications, spreadsheet applications, imaging applications, graphics applications, browsing applications, presentation applications, and the like. The skilled artisan will further appreciate that each such application includes one or more associated drivers, which facilitate the output of document data from the application to a designated port, e.g., the virtual port established by the port redirector component.

At step 504, the port redirector component resident on the user device 124 stores the output data received at the virtual port in a known storage location, e.g., the data storage device 126. In accordance with one embodiment of the subject application, the data storage device 126 includes a dedicated storage location for storing output data received from applications, e.g., software drivers, directed to the virtual port. Display data is then generated at step 506 by the port redirector component of the user device 124 representing at least one document associated with the output data stored in the data storage device 126. In accordance with one embodiment of the subject application, the port redirector component, via the user device 124, initiates a custom graphical user interface application displaying at least one of the documents associated with the output data so as to enable the user to modify, delete, set output preferences, and the like associated with the displayed document.

At step 508, the user device 124, via the associated display, generates document processor display data representative of the available document output devices, e.g., the first document processing device 104 and the second document processing device 114. The skilled artisan will appreciate that the user device 124 displays to the user those document processing devices 104 and 114 available for output of the output data received at the virtual port. Selection data corresponding to one or more selected document output devices 104 and 114 is then received from the associated user via the graphical user interface of the user device 124 at step 510. At step 512, copy count data is then received for each selected document output device 104 and 114 representing a number of copies to be output on each corresponding document output device 104 and 114. Thereafter, at step 514, the port redirector component of the user device 124 facilitates the output of the output data from the data storage device 126 to each selected document processing device 104 and 114 such that each document output device 104 and 114 outputs a number of copies corresponding the copy count data associated with the respective device 104 and 114. Stated another way, the port redirector component facilitates the communication of the documents of the output data to each document processing device 104 and 114, enabling each document processing device 104 and 114 to print a number of copies of the documents corresponding to the received copy count data.

Referring now to FIG. 6, there is shown a flowchart 600 illustrating a method for customized routing of document data intercepted though port redirection in accordance with one embodiment of the subject application. The methodology depicted in FIG. 6 begins at step 602, whereupon a port redirector component is initiated on a user device 124. It will be appreciated by those skilled in the art that the port redirector component is any software, hardware, or suitable combination thereof capable of facilitating the receipt and interception of output data from one or more software drivers associated with applications resident on the user device 124. At step 604, the port redirector component establishes a virtual port on the user device 124 representative of a destination for output data from the software drivers associated with the applications.

Output data is then received at step 606 from the software drivers associated with the applications resident on the user device 124. The skilled artisan will appreciate that the software driver is capable of being directed to commence a document processing operation, such as printing, facsimile, electronic mail, storage, or the like, by a user via the associated application. The output data received into the virtual port from the software drivers includes, for example and without limitation, graphical image data, post-raster image processing graphical image data, or the like. The received output data is then stored, via direction of the port redirector component, in a known storage location, e.g., the data storage device 126 at step 608.

Upon the receipt and storage of the received output data, the port redirector component directs the initialization of a graphical component, which generates a graphical user interface on the user device 124 at step 610. In accordance with one embodiment of the subject application, a custom application is launched on the user device 124 associated with the receipt of output data at the virtual port. In accordance with a further embodiment of the subject application, the graphical user interface is generated via an associated thin client, e.g., the port redirector and corresponding applications are accessed via thin client, such as a web browser over the computer network 102.

At step 612, document images corresponding to the output data are generated via the graphical user interface associated with the user device 124. The port redirector component then identifies those document processing devices 104 and 114 accessible via the computer network 102 and available for use in the performance of the document processing operations directed by the software drivers at step 614. The available document processing devices 104 and 114 are then displayed to the user at step 616 via the associated graphical user interface. The skilled artisan will appreciate that the display of the available document processing devices 104 and 114 is capable of including, for example and without limitation, icons representative of the devices, a list of available devices, or any other indicia, as will be known in the art. The port redirector component then receives, via the associated graphical user interface, selection data corresponding to one or more document processing devices 104 and 114 selected by the user to perform the associated document processing operations at step 618.

The user is then prompted, at step 620, for set data corresponding to the first set of copies, i.e., a number of copies to be output on a corresponding document processing device 104 or 114 and separator page data corresponding to a characteristic of a job information page unique to each selected document processing device 104 or 114. In accordance with one embodiment of the subject application, the separator page data includes the identity of an associated document processing device 104 or 114 and the copy count associated with the set to be output by the identified document processing device 104 and 114. The port redirector component, via the s associated graphical user interface, then receives, at step 622, the copy count and separator page content for the set of copies from the associated user. According to one embodiment of the subject application, the received separator page data includes, for example and without limitation, text strings defined by the user, and the like.

A determination is then made at step 624 whether another set is to be added to the output data. When it is determined that at least one additional set of copies is to be generated from the output data, flow proceeds to step 626, whereupon the user is prompted via the associated graphical user interface to input copy count data and separator page content corresponding to the next set of copies. Flow then returns to step 622, whereupon the selected copy count data and separator page data associated with the second copy set is received by the port redirector component of the user device 124. When it is determined at step 624 that no additional sets of copies are to be generated from the output data, flow progresses to step 628, whereupon the port redirector component generates modified output data inclusive of each set of copies and corresponding copy count data and separator page contents. The modified output data is then stored, at step 630, in the data storage device 126 associated with the user device 124. Thereafter, at step 632, the modified output data is communicated, via the computer network 102, to the selected document processing devices 104 and 114.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for customized routing of document data intercepted though port redirection comprising:
virtual port means adapted for receiving output data from at least one application;
a data storage adapted for storing output data received via the virtual port;
means adapted for generating, on an associated display, display data representative of at least one electronic document associated with output data stored in the data storage;
means adapted for generating, on the display, document processor display data representative of a plurality of available document output devices;
means adapted for receiving selection data representative of selected document output devices from the plurality thereof;
means adapted for receiving, for each selected document output device, copy count data representative of a number of copies to be output on each corresponding document output device; and
means adapted for outputting output data from the data storage to each selected document output device such that each selected document output device outputs a number of copies corresponding to copy count data associated therewith.

2. The system of claim 1 further comprising means adapted for receiving separator page data representative of a characteristic of a job information page unique to each selected document processing device.

3. The system of claim 2 wherein separator page data includes at least one of data representative of an identity of and copy count associated with each document output device.

4. The system of claim 3 further comprising means adapted for commencing generation of each job information page as a separator page between each copy output by each document output device.

5. The system of claim 2 further comprising at least one software driver associated with each of the plurality of available document output devices, and wherein output data is received into the virtual port therefrom.

6. The system of claim 5 wherein the at least one document output device includes a multifunction peripheral, and wherein the at least one software driver is directed to commence at least one operation chosen from the set of printing, facsimile transmission, and electronic mail transmission.

7. The system of claim 6 wherein the output data includes graphical image data.

8. A method for customized routing of document data intercepted though port redirection comprising the steps of:
receiving, via a virtual port, output data from at least one application;
storing output data received via the virtual port in an associated data storage;
generating, on an associated display, display data representative of at least one electronic document associated with output data stored in the data storage;
generating, on the display, document processor display data representative of a plurality of available document output devices;
receiving selection data representative of selected document output devices from the plurality thereof;
receiving, for each selected document output device, copy count data representative of a number of copies to be output on each corresponding document output device; and
outputting output data from the data storage to each selected document output device such that each selected document output device outputs a number of copies corresponding to copy count data associated therewith.

9. The method of claim 8 further comprising the step of receiving separator page data representative of a characteristic of a job information page unique to each selected document processing device.

10. The method of claim 9 wherein separator page data includes at least one of data representative of an identity of and copy count associated with each document output device.

11. The method of claim 10 further comprising the step of commencing generation of each job information page as a separator page between each copy output by each document output device.

12. The method of claim 9 wherein output data is received into the virtual port via a software driver associated with each of the plurality of available document output devices.

13. The method of claim 12 wherein the at least one document output device includes a multifunction peripheral, and further comprising the step of directing the at least one software driver to commence at least one operation chosen from the set of printing, facsimile transmission, and electronic mail transmission.

14. The method of claim 13 wherein the output data includes graphical image data.

15. A computer-implemented method for customized routing of document data intercepted though port redirection comprising the steps of:
receiving, via a virtual port, output data from at least one application;
storing output data received via the virtual port in an associated data storage;
generating, on an associated display, display data representative of at least one electronic document associated with output data stored in the data storage;
generating, on the display, document processor display data representative of a plurality of available document output devices;
receiving selection data representative of selected document output devices from the plurality thereof;
receiving, for each selected document output device, copy count data representative of a number of copies to be output on each corresponding document output device; and
outputting output data from the data storage to each selected document output device such that each selected document output device outputs a number of copies corresponding to copy count data associated therewith.

16. The computer-implemented method of claim 15 further comprising the step of receiving separator page data representative of a characteristic of a job information page unique to each selected document processing device.

17. The computer-implemented method of claim 16 wherein separator page data includes at least one of data representative of an identity of and copy count associated with each document output device.

18. The computer-implemented method of claim 17 further comprising the step of commencing generation of each job information page as a separator page between each copy output by each document output device.

19. The computer-implemented method of claim 16 wherein output data is received into the virtual port via a software driver associated with each of the plurality of available document output devices.

20. The computer-implemented method of claim 19 wherein the at least one document output device includes a multifunction peripheral, and further comprising the step of directing the at least one software driver to commence at least one operation chosen from the set of printing, facsimile transmission, and electronic mail transmission.
